(19) United States
(12) Patent Application Publication
(10) Pub. No.: US 2005/0077330 A1
(43) Pub. Date: Apr. 14, 2005

(54) Child sling

(76) Inventor: Joyce Fernandez, Wappingers Falls, NY (US)

Correspondence Address: Joseph B. Taphorn, 8 Scenic Drive, Hagan Farms, Poughkeepsie, NY, 12603, US

(21) Appl. No.: 10/683,616

(22) Filed: Oct. 14, 2003

(51) Int. Cl. A61G 1/00

(52) U.S. Cl. 224/160

(57) ABSTRACT

A child's sling is formed of a cross-wise channel near midway between its ends and with a pocket on the end of the longer one of its branches. When used for carrying child in the cross-carry position, the sling is looped over the head so that the channel is in the middle of the lower back and the branches extend down in front of the would-be carrier. The branches are then passed across the chest and through the channel in the back and continued around and back in front where they are tied in a knot after adjusting the sling for suitable comfort of a carried child. Advantageous use may be made of the channel to carry a child in other positions such as the single-shoulder-carrying position. For this position, the channel is placed on top of the shoulder and the branches of the sling brought around the body below the other shoulder and up through the channel and tied in a knot. The sling may be used for other purposes too, such as a shawl.

### FIELD OF THE INVENTION

This invention relates to child slings, and more particularly to a child sling for persons having a weak lower back.

### BACKGROUND OF THE INVENTION

Child slings are well known. Various types of child slings may be viewed at the web sites http://kangarookorner.com and http://Mama.Roo.com.

Unfortunately, existing child slings are hard on a person's lower back. They are especially difficult for women having lower back (lumbar region) pain.

Lower back pain can arise from different causes. One is a spondylitis condition which may involve a vertebra slipping forward on the one below it. Another is a fracture in the pars intrarticularis, a structure at the back of the vertebra that is compressed when the back is arched backward as when carrying a child in front in a fabric sling.

### PRIOR ART

One such fabric sling is the German Didymos sling, also known as the German Girosol sling, described on the web site “http://kangarookorner.com/k reviews fabric.shtml”. The Didymos sling is essentially a twelve foot or so long, one foot wide piece of fabric. With the Didymos sling, when the child is to be carried in the cross-carry position (facing the front of the carrier's upper torso), the middle of the sling is draped over the carrier's shoulders so that it loops down to the middle of the carrier's back and so that one of the branches hangs down in front of the carrier about a foot longer than the other. Then the two branches are crossed in front of the carrier's chest to his or her waist, the longer branch being inside the other and being passed behind the carrier and through the loop in back and brought to the other side where it is tied in a loose knot with the outside branch. The child is then placed vertically facing the carrier and so that its leg opposite the shoulder over which the inside branch passes, is inside the inside branch; and so that the other leg is inside the other or outside branch but outside the inside and longer branch. The branches are spread to widely cover the child's buttocks and shoulders and to support it comfortably.

A known disadvantage of using the Didymos sling in the cross-carry position is that it is ill-suited to nursing. This is because you must wear your baby high on your chest to avoid back pain.

And I have discovered that if you already have back pain, even wearing your baby high does not save you from increased back pain.

### SUMMARY OF THE INVENTION

Accordingly, it is an object of this invention to provide a child's sling which does not cause back pain when used for the Cross-Carry position.

A more particular object of the invention is to provide a child's sling which accommodates use by a person already having lower back pain.

Thus a specific object of the invention is to provide a child's sling which does not increase the back pain already being experienced by the carrier.

It is another object of the invention to provide such a child's sling which is easy to use.

Still another object of the invention is to provide such a child's sling which is simple of construction and easy and inexpensive of manufacture.

Yet another object of the invention is to provide such a child's sling which is adaptable for other positions such as the Single-Shoulder-Carrying position, and other uses such as a shawl.

A further object of the invention is to provide a child's sling which lends itself to a new child-supporting arrangement.

The objects of the invention are achieved by incorporating a channel, preferably a cross-wise channel, in the lower-back loop area (near the middle) of the child's sling, aided by a new child supporting arrangement. If the sling is eighteen feet long, this essentially means that the channel is nine and one-half (9½) feet from the longer branch end and eight and one-half feet from the other. The channel is of a size to easily pass both branches of the sling there through.

The new mounting arrangement includes passing the sling's second branch through the channel or loop and tying the free ends of the branches together in a tight knot.

A feature of the new sling is that it also incorporates an endwise pocket at the end of a branch of the sling, for holding baby needs. Preferably, the endwise pocket is on the longer branch of the sling.

An advantage of the invention is that the child's sling is extraordinarily adaptable to other positions such as the Single-Shoulder-Carrying position. The sling may be positioned so that the channel is above a shoulder of the would-be carrier, and a sling branch passed behind and under the opposite shoulder and brought across the front and up to the channel and passed there through to secure the shoulder location of the sling and tie the branch to the other branch of the sling.

Another advantage of the invention is that the child's sling is readily adaptable to other uses such as a shawl. The shawl use of the child's sling is facilitated by the channel providing a means for holding the shawl in place through passage of one or both branches there through.

### BRIEF DESCRIPTION OF THE DRAWINGS OF PREFERRED EMBODIMENTS OF THE INVENTION

These and other objects, features, and advantages of the invention will become apparent from a reading of the following description of preferred embodiments of the invention when considered with the accompanying drawings wherein:

FIG. 1 is a sketch depicting a front view of a person wearing the child's sling of the invention with a child in place using the cross-carry position;

FIG. 2 is a sketch depicting a back view of a person wearing the child's sling of the invention using the cross-carry position;

FIG. 3 is an elongated view of the top flat side of the child's sling of the invention;

FIG. 4 is a right side edge view of the sling of FIG. 3;

FIG. 5 is a sketch depicting a front view of using of the child's sling of the invention for the Single-Shoulder-Carrying position; and

FIG. 6 is a sketch depicting a back view of using of the child's sling of the invention for the Single-Shoulder-Carrying position.

### DETAILED DESCRIPTION OF PREFERRED EMBODIMENTS

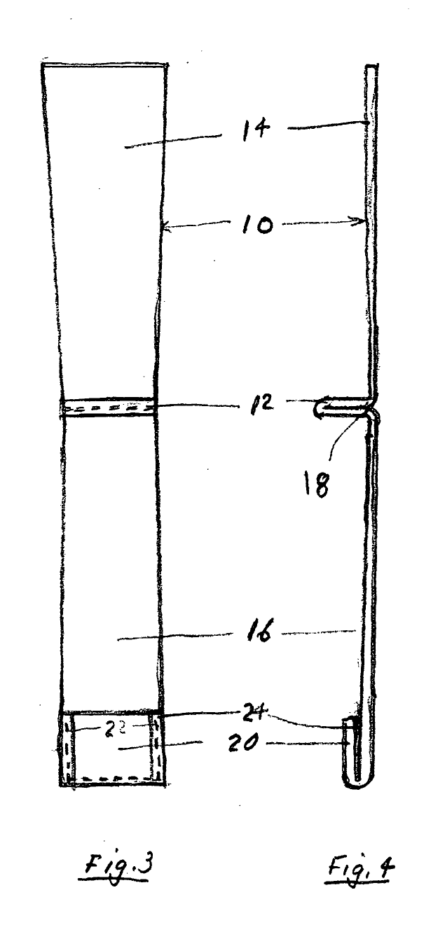

Referring now to the drawings, the child's sling of the invention is shown in FIGS. 3 and 4. As noted earlier, the sling, generally indicated by the numeral 10, is normally a thin piece of elongated fabric which may be six or so yards long and two feet or so wide, and of sufficient tensile strength to support a child.

The sling 10, near its midpoint, mounts crosswise a channel 12 through which its upper and lower branches 14 and 16, respectively, may be passed when the sling is over the carrier's back. The channel 12 is formed by folding the length of the fabric so that one branch is about one (1) foot longer than the other, and then sewing a straight line 18 across the width of the fabric about seven (7) inches away from the centerfold. Thus you end up with a seven (7) inch piece of fabric sticking out near the middle of the length of the extended fabric, and constituting a channel through which the brances of the fabric may be passed.

The channel 12 may also be formed by stitching an extra piece of fabric onto the top of the sling 10. Or it may be formed by cutting the fabric an extra length and in two, and overlaying the abutting ends and stitching them together. As shown in the drawings, preferably the channel 12 is mounted off-center the sling's length, to leave a shorter upper branch 14 and a longer lower branch 16 to accommodate mounting a pocket 20 for use while carrying the sling.

The pocket 20 is mounted on the end of the lower longer branch 16. It may be formed by cutting the sling fabric a little longer and folding the extra length upwards and stitching as at 22 the side edges 24 of the extra length to the lower branch 16, leaving the upper edge of the extra length free to enable insertion and removal of items into and from the pocket 20. The pocket 20 may be formed differently, as by sewing a cut piece of material to the branch 16.

The child's sling of the invention would be mounted by the carrier by looping the sling 10 over the carrier's back and so the channel 12 was the lower portion and waist high. Channel 12 should be directly in the center of the lower back.

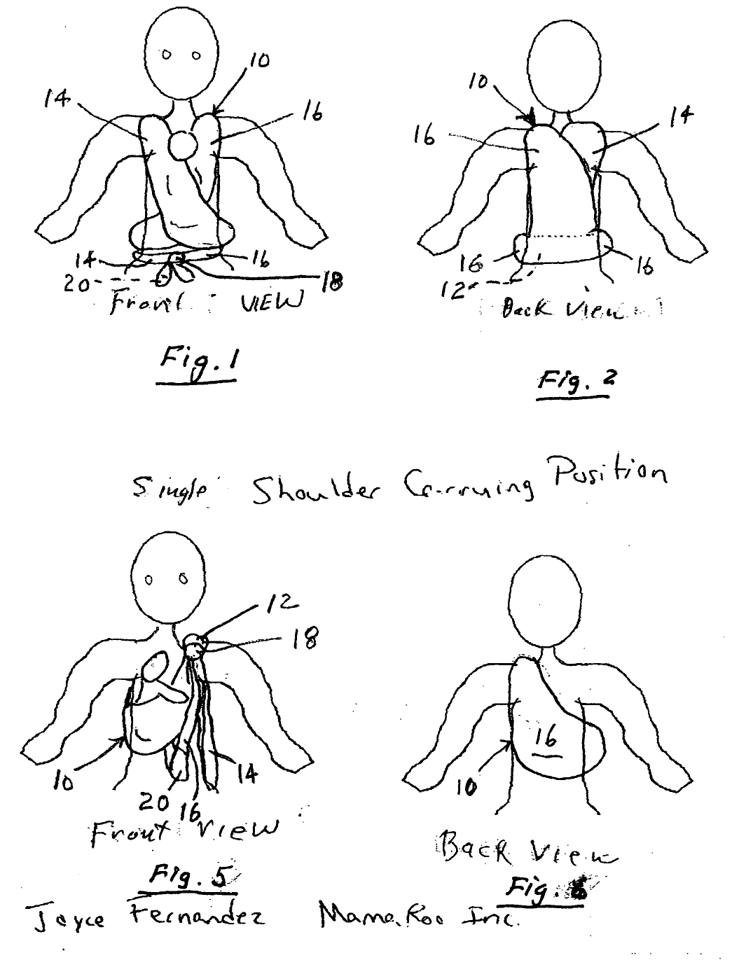

Thereafter the two branches 14 and 16 are crossed in front of the carrier's waist, the longer branch 16 being inside the other and being passed behind the carrier and through the channel 12 in back; then the shorter and outside branch 14 is passed through the channel 12 in the other direction and inside or outside or above or below the other (in FIG. 2 depicted inside the other); thereafter the branches are continued around the carrier's waist and tied together in a loose knot in front. The child is then placed vertically facing the carrier and so that its leg opposite the shoulder over which the inside branch 16 passes, is inside the inside branch; and so that the other leg is inside the other or outside branch 14 but outside the inside and longer sling branch 16. The branches 14 and 16 are spread to widely cover the child's buttocks and shoulders and loosened or tightened to support it comfortably. Then the knot in the branches 14 and 16 may be tightened, as by making it a square knot 18 (FIG. 1), to secure the child in place. The branches should be tied directly in the center in the front of the carrier and under or around the child.

To dismount the child, the square knot 18 might first be untied with both hands, the child grasped with one hand while the knot was loosened more with the other hand, and then the sling branches 14 and 16 loosened about the child and the child removed from the sling.

To dismount the sling, the earlier steps in mounting the sling are just reversed in turn.

It will be appreciated that the passage of one or both of the branches 14 and 16 through the channel 12 at the bottom of the looped sling behind the lower back of the carrier and the tying of the passed branches securely in front of the carrier, may load the carrier below the spondylitis condition or the fracture in the pars intrarticularis and enable less-painful use in the Cross-Carry position of a child's sling.

FIGS. 5 and 6 depict using of the child's sling of the invention for the Single-Shoulder-Carrying position. The figures show the channel 12 atop the left shoulder of the carrier. The longer branch 16 extends down in back from the left shoulder and around the waist below the carrier's right shoulder and up to the left shoulder and passes through the channel 12; the other branch 14 extends, inside the branch 16, down the front and around the waist below the right shoulder and up the back and through the channel, and is tied to the other branch 16.

When using the child's sling as a shawl, an end of the sling would be passed over the head or shoulders, and a branch or branches passed through the channel to hold the shawl firmly in place.

While there has been shown and described preferred embodiments of the invention, it will be clear to others experienced in the art, that other and different applications may be made of the principles of the invention. It is therefore desired to be limited only by the scope or spirit of the appended claims.

1. A child's sling having a channel between its ends for passing a branch of the sling there through.

2. A child's sling according to claim 1, wherein the sling is an elongated piece of fabric.

3. A child's sling according to claim 1, wherein the channel is near the middle of the sling.

4. A child's sling according to claim 3, wherein the channel extends cross-wise of the sling.

5. A child's sling according to claim 1, wherein is also formed a pocket for holding child-care things.

6. A child's sling according to claim 1, wherein the sling is an elongated piece of fabric, wherein the channel is near the middle of the sling and extends cross-wise of the sling, and wherein is also formed a pocket for holding child-care things.

7. A child's sling for the cross-carrying position comprising an elongated piece of fabric having a channel disposed between its ends so as to be in the middle of the would-be-carrier's lower back when the sling is looped over the carrier's head.

8. A child's sling for the cross-carrying position according to claim 7, wherein a first branch of the sling is passed across the front of the would-be carrier and around the back through the channel and to the front of the would-be-carrier.

9. A child's sling for the cross-carrying position according to claim 8, wherein the other branch is passed in the other direction across the front of the would-be carrier and around the back and to the front of the would-be-carrier and tied in a knot with the first branch.

10. A child's sling for the cross-carrying position according to claim 8, wherein the other branch is passed in the other direction across the front of the would-be carrier and around the back through the channel and to the front of the would-be-carrier and tied in a knot with the first branch.

11. A child's sling for the cross-carrying position according to claim 9, wherein the knot is loosely tied at first and tied securely after the child has been placed in the sling and the sling adjusted to sit the child comfortably therein.

12. A child's sling for the cross-carrying position according to claim 10, wherein the knot is loosely tied at first and tied securely after the child has been placed in the sling and the sling adjusted to sit the child comfortably therein.

13. A child's sling for the cross-carrying position according to claim 11, wherein a pocket for holding child-care things is formed in a branch of the sling and the pocket is beyond the knot.

14. A child's sling for the cross-carrying position according to claim 12, wherein a pocket for holding child-care things is formed in a branch of the sling and the pocket is beyond the knot.

15. A child's sling for the single-shoulder-carrying position, comprising an elongated piece of fabric having a channel disposed between its ends so as to be on top of the would-be-carrier's shoulder when the sling is draped there over.

16. A child's sling for the single-shoulder carrying position according to claim 15, wherein a first branch of the sling is passed across the front of the would-be carrier and around and up the back and through the channel on the shoulder of the would-be-carrier.

17. A child's sling for the single-shoulder carrying position according to claim 16, wherein the other branch is passed around the back and to and across the front of the would-be carrier and up to and through the channel and tied in a knot with the first branch.

18. A method for carrying a child in a sling having a channel between its ends, comprising a first step of disposing the sling on a would-be carrier so that the channel is located for receiving one of its free ends, and the step of disposing a branch of the sling so as to extend through the channel, wherein the other branch is passed in the other direction across the front of the would-be carrier and around the back through the channel and to the front of the would-be-carrier and tied in a knot with the first branch.

19. A method for carrying a child in a sling having a channel between its ends according to claim 18, wherein the sling is disposed so that the channel is located in the middle of the lower back and the branches of the sling extend forward over the would-be carrier's shoulders, and the step of passing a first branch of the sling across the front of the would-be carrier and around the back through the channel and to the front of the would-be-carrier, and the step of passing the other branch in the other direction across the front of the would-be carrier and around the back through the channel and to the front of the would-be-carrier and tying in a knot with the first branch.

20. A method for carrying a child in a sling having a channel between its ends according to claim 18, wherein the sling is disposed so that the channel is located on the shoulder of a would-be carrier, and the step of passing a first branch of the sling across the front of the would-be carrier and around and up the back and through the channel on the shoulder of the would-be-carrier, and the step of passing the other branch around the back and to and across the front of the would-be carrier and up to and through the channel and tying in a knot with the first branch.
